(19) United States
(12) Patent Application Publication
(10) Pub. No.: US 2006/0033984 A1
(43) Pub. Date: Feb. 16, 2006

(54) Optical mount with UV adhesive and protective layer

(75) Inventors: Stephane Bruynooghe, Aalen (DE); Jens Ullmann, Oberkochen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 10/914,278

(22) Filed: Aug. 10, 2004

(51) Int. Cl. G02B 1/00

(52) U.S. Cl. 359/350; 359/820

(57) ABSTRACT

An assembly includes a holder (5), an optical component (1) transmitting radiation in a first region of ultraviolet (UV) radiation adhered to the holder by an adhesive (4), the adhesive being hardenable by radiation of a second region of ultraviolet radiation, a first layer (3) disposed between the optical component and the adhesive, and a second layer (2) for enhancing adhesion between the optical component and the first layer. The first layer is capable of transmitting radiation of the second region of UV radiation and obstructing to a high degree transmission of UV radiation of the first region by at least one of absorption and reflection. The optical component has a transmitting zone and the first layer is located outside of the transmitting zone. The second layer for enhancing adhesion between the optical component and the first layer is disposed between the first layer and the optical component. The assembly can be used, for example, in an illumination system and/or a projection system of a microlithography projection apparatus.

### BACKGROUND OF THE INVENTION

1. Field of the Invention

The invention relates to an assembly including a holder—in particular, a mount—and an optical component adhered to the holder by an adhesive, wherein the optical component is suitable for transmitting radiation in a first region of ultraviolet (UV) radiation, and wherein the adhesive is hardened by UV radiation in a second region of ultraviolet radiation, the adhesive being protected from radiation of the first region of ultraviolet radiation by an adhesive-protecting layer.

2. Description of the Related Art

Japanese Patent Application JP 8-72300 provides an example of an assembly with an ultraviolet curable adhesive. Such assemblies form, among other things, mounted lenses and the like of illumination systems and projection systems for microlithography.

Japanese Patent Application JP 11-014876 describes a protective member for shielding the surface of the adhesive of such an assembly from ultraviolet radiation transmitted by the optical component during use of the optical component.

Thin layers of dielectrics for protecting an adhesive, in particular layers with thicknesses in the micrometer range, are known in the optical field, and are applied by vacuum deposition, PVD or CVD. Such a protective layer for UV hardening bonds is described in Japanese Patent publication JP 9-184917.

It has been found that the known mount adhesives based on epoxy resin, which can be hardened with UV radiation of a region consisting only of wavelengths larger than 300 nm and including an Hg-I line at 365 nm, can be considerably damaged by irradiation with UV radiation from the deep UV region, in particular at about 248 nm, 193 nm or 157 nm. UV absorbing fillers in the adhesive mass do not prevent failure of the boundary layer of the adhesive adjacent to the optical component. U.S. Pat. document No. 6,097,536 describes an assembly comprising a protective layer shielding the adhesive from radiation below approximately 300 nm, but allowing curing of the adhesive at higher wavelengths.

Material properties of optical components transparent for UV radiation may differ considerably from material properties of the adjacent protective layer, a circumstance which may cause the tensile or compression strength between the two to be insufficient to assure long term stability of the mechanical bond between the optical component and the holder.

### SUMMARY OF THE INVENTION

It is one object of the invention to provide an assembly of the stated kind, wherein the tensile or compression strength between all parts of the assembly is large enough to assure long-term stability of the assembly. Providing a process for producing the assembly, an optical component and microlithography projection exposure equipment including the assembly as part of an illumination and/or projection system also are objects of the invention.

These and other objects are achieved by an assembly including a holder, an optical component suitable for transmitting radiation in a first region of ultraviolet (UV) radiation and adhered to the holder with an adhesive, the adhesive being capable of being hardened by radiation of a second region of ultraviolet radiation. The assembly further includes a first layer disposed between the optical component and the adhesive, the first layer being capable of transmitting radiation of the second region of UV radiation and obstructing to a high degree transmission of UV radiation of the first region by absorption and/or reflection, thus forming an adhesive-protecting layer. The optical component has a transmitting zone, and the first layer is located outside of the transmitting zone. The assembly further includes a second layer for enhancing adhesion between the optical component and the first layer, the second layer being disposed between the first layer and the optical component.

The adhesion-enhancing second layer mediates between mechanical and chemical properties of the optical component and the adhesive-protecting layer. Therefore, it allows using materials for the adhesive-protecting layer whose chemical and mechanical properties do not match directly those of the optical component. The adhesion-enhancing layer should be suitable for assuring a tensile strength of more than 10 N/mm² between the optical component and the adhesive-protecting layer.

In one embodiment of the invention, a thermal expansion coefficient of the second, adhesion-enhancing layer is closer to a thermal expansion coefficient of the optical component than to a thermal expansion coefficient of the first, adhesive-protecting layer. Thermal expansion coefficients of fluoride materials used for optical components transmitting below 300 nm lie typically in a range of about 10⁻⁵ /K. Thermal expansion coefficients of oxide materials which are preferably used for the adhesive-protecting layer lie typically in a range of about 10⁻⁶ /K. By choosing the thermal expansion coefficient of the adhesion-enhancing layer closer to the range of values of fluoride materials than to the range of values of oxide materials, a good thermal stability of the adhesion between the optical component and the adhesion-enhancing layer is ensured.

In one embodiment of the invention, the optical component is composed of a first fluoride material, in particular CaF₂, and the adhesion-enhancing layer is, at least in a zone adjacent to the optical component, composed of a second fluoride material, particularly one of MgF₂, LaF₃, GdF₃, NdF₃, AlF₃, cryolite, chiolite, CeFₓ, YFₓ, or mixtures thereof. Material properties of the adhesion-enhancing layer and the optical component are similar due to the fact that both are consisting of fluoride materials and therefore sufficient tensile strength between the two is assured.

The adhesive protecting layer may, at least in part, be composed of an oxide material, in particular of Ta₂O₅.

In one embodiment, the adhesion-enhancing layer is a gradient layer having a first zone adjacent to the optical component consisting of a first material and a second zone adjacent to the adhesion-protecting layer consisting of a second material, the second material being different from the first material. The first material is chosen such that it is suitable for enhancing adhesion between the first zone and the optical component and the second material is chosen such that it is suitable for enhancing adhesion between the second zone and the adhesion-protecting layer. Transition between the first zone and the second zone can be accomplished by a stepwise or a continuous change of composition. Optimum adhesion can thus be obtained on both interfaces of the adhesion-enhancing second layer.

A continuous change of composition between the first and the second material can be advantageously accomplished by a process of ion mixing. During this process, the surface of the first material is irradiated with ions while a deposition of the second material on the first material is taking place, e.g. by physical vapor deposition. As a result, ions of the second material and/or ions of a third material, for example ions of an inert gas, are accumulated inside of the first material on a length ranging from the surface of the material to the maximum ion penetration depth, thereby forming an ion mixing layer. By adjusting the kinetic energy of the irradiating ions it is possible to adjust the thickness of the ion mixing layer.

A stepwise transition may be obtained by alternately depositing thin layers of the first and at least one second material wherein the layer thicknesses vary across the gradient layer to obtain a desired gradient of a mean composition.

It is possible to create an adhesion-enhancing second layer which includes a thin border layer adjacent to the adhesive-protecting layer formed by ion mixing. The remainder of the second layer may be composed by the second material only.

A production process according to the invention involves coating an optical component suitable for transmitting radiation in a first region of ultraviolet (UV) radiation on a surface outside of a transmitting zone with a second layer, coating the second layer with a first layer, the first layer being optimised for obstructing to a high degree transmission of ultraviolet (UV) radiation of the first region by at least one of absorption and reflection and transmitting radiation of a second region of UV radiation in which an adhesive hardens, the second layer enhancing adhesion between the optical component and the first layer, applying the adhesive between the first layer and a holder, and hardening the adhesive by irradiating the adhesive with UV radiation in the second region of radiation that passes through the optical component and the first and second layer.

Coating of the first and/or second layer can be performed by at least one thin film process such as vapor deposition, sputtering, physical vapor deposition (PVD), spraying, chemical vapor deposition (CVD), ion assisted deposition (IAD), plasma enhanced chemical vapor deposition (PECVD), spincoating or another deposition technique. It can be particularly advantageous to combine the processes of physical vapor deposition or chemical vapor deposition with ion assistance.

An optical component according to the invention has a transmitting zone and a surface arranged outside of the transmitting zone, the surface being coated by a second layer, the second layer being coated by a first layer suitable for protecting the adhesive from radiation in a first region of ultraviolet (UV) radiation transmitted by the optical component during use of the optical component, the second layer being adapted for enhancing adhesion between the optical component and the first layer. The optical component can be adhered to a holder with an adhesive, to form a mechanically stable assembly.

### BRIEF DESCRIPTION OF THE DRAWINGS

Beneficial embodiments of the invention are depicted in the accompanying figures and shall be described below. In the accompanying figures:

FIG. 1 shows a first embodiment of an assembly according to the invention in a schematic detail view,

FIG. 2 shows the boxed region of FIG. 1 in a schematic view,

FIG. 3 shows a second embodiment of an assembly according to the invention in a schematic detail view,

FIG. 4 shows a third embodiment of an assembly according to the invention in a schematic detail view, and

FIG. 5 shows a schematic diagram of the composition of an ion mixing layer of FIG. 4.

### DETAILED DESCRIPTION OF PREFERRED EMBODIMENTS

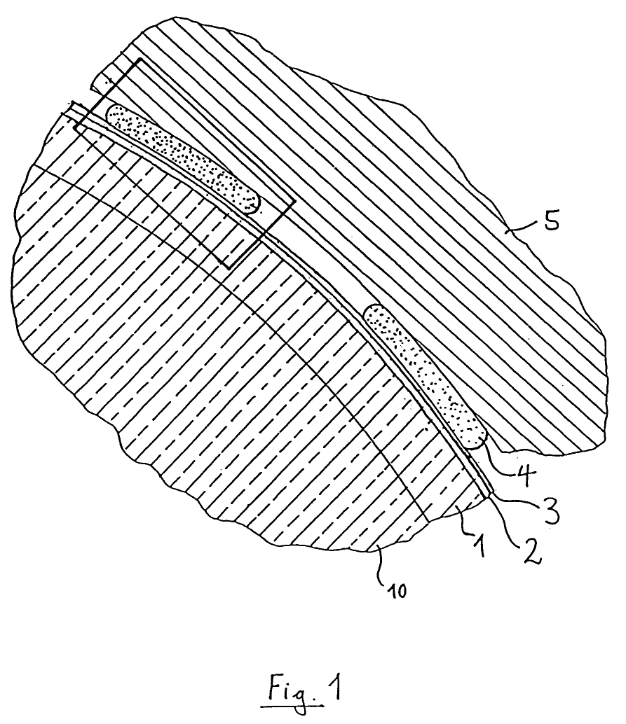

The assembly schematically shown in FIG. 1 has an optical component 1, namely a lens. In other embodiments, the optical component may be a flat plate, a prism, a Mangin mirror or a transmitting diffractive optical element. The optical component 1 includes a circular transmitting zone 10, within which the component 1 is capable of transmitting UV radiation from the VUV or DUV region, e.g. laser radiation at about 248 nm, 193 nm or 157 nm, essentially without absorption. Outside of the transmitting zone 10, on the edge of the transparent component 1, an adhesion-enhancing second layer 2 is applied, covering the edge of the component 1 continuously or as a distributed section. The adhesion-enhancing layer 2 is covered continuously by an adhesive-protecting first layer 3. The assembly additionally includes a holder (lens mount 5) made of metal. In other embodiments, the holder may be made of plastics or ceramic/glass-ceramic. The holder material is not transparent to ultraviolet (UV) radiation. The optical component 1 and the mount 5 are mechanically connected by layers 4 of adhesive, which are formed as a distributed section over the edge of the adhesion-protective layer 3 to form fixing regions having a circumferential distance to each other. The adhesive layers 4 may alternatively be applied as a continuous layer. Each adhesive layer 4 consists of UV-hardenable (or UV-hardened) adhesive based on epoxy resin, such as, e.g., Omnifit UV-4000 of Omnitechnic GmbH, Hannover, Germany.

The adhesive-protecting first layer 3 is provided, because the adhesive is photochemically unstable to light with wavelengths of an UV region below 300 nm, in particular radiation from lasers at about 248 nm, 193 nm or 157 nm—as required in some projection exposure equipment for microlithography such as illumination systems or projection systems. For the adhesive-protecting first layer 3 a layer of tantalum pentoxide Ta₂O₅ is suitable and can be applied like an optical layer, e.g. by vapor deposition or other thin film processes.

The optical component 1 in the embodiment of FIG. 1 consists of CaF₂, but other fluoride materials transmitting ultraviolet radiation below 200 mn, such as LiF, MgF₂, BaF₂ can also be used. An adhesion-enhancing second layer 2 consisting essentially of MgF₂ is disposed between the optical component 1 and the adhesive-protecting layer 3 in order to enhance the tensile strength between the two. Other fluoride materials, such as LaF₃, GdF₃, NdF₃, AlF₃, cryolite, chiolite, CeFₓ, YFₓ, and mixtures thereof are other possible materials for forming the adhesion-enhancing layer 2. The chemical structure and thermal expansion coefficient of the adhesive-protecting layer 2 are similar to those of the optical component 1, such that cohesion between the two is assured even when the temperature of the assembly changes, e.g. by heating of the optical component 1 caused by irradiation with ultraviolet radiation.

The adhesive in this arrangement can be hardened through the transparent optical component 1, the adhesive-enhancing layer 2 and the adhesion-protecting layer 3 with Hg-I light of a high-pressure mercury lamp at about 365 nm. The optical component 1, consisting of CaF₂, and the adhesion-enhancing second layer 2, consisting of MgF₂, both transmit radiation of a region above 300 nm almost without losses to a high degree. The adhesive-protecting layer, consisting of Ta₂O₅, attains a transmission of more than 60% in this regime of UV radiation. The reflectivity of the adhesive-protecting layer 2 in a region of UV radiation below 300 nm is lower than 10%, such that the creation of straylight is avoided to a high degree.

The assembly of FIG. 1 can be used in an illumination system or in a projection objective of a microlithography projection exposure equipment, for example. Other DUV applications are possible, e.g. within a laser.

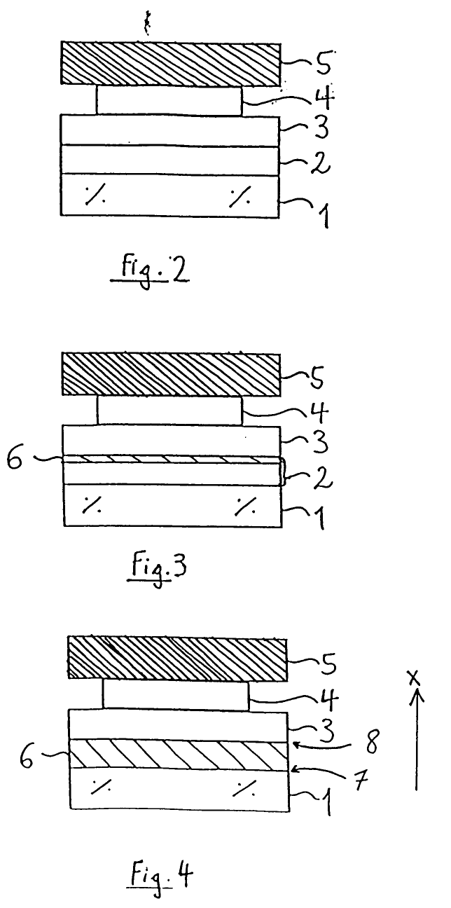

FIG. 2 shows the boxed region of FIG. 1 in a schematic detail view, i.e. it shows in succession the optical component 1, the adhesion-enhancing layer 2, the adhesive-protecting layer 3, the adhesive layer 4 and the mount, respectively optical holder 5. In FIG. 2 the above parts of the assembly are shown as rectangular boxes in order to illustrate the sequence of their arrangement.

The schematic view of the second assembly of FIG. 3 differs from the one shown in FIG. 2 in that an ion mixing layer 6 is disposed in the transition region between the adhesion-enhancing layer 2 and the adhesive-protecting layer 3. The thickness of the ion mixing layer 6 is much smaller than that of the adhesion-enhancing layer 2. The ion mixing layer 6 is formed on the adhesion-enhancing layer 2 by irradiation of its surface with gas ions, e.g. oxide ions, while at the same time tantalum pentoxide Ta₂O₅ is deposited on the surface by physical vapor deposition. As a result, tantalum pentoxide Ta₂O₅ is accumulated not only on the surface but also inside of the material forming the adhesion-enhancing layer 2 on a length ranging from the surface of the material to the maximum ion penetration depth.

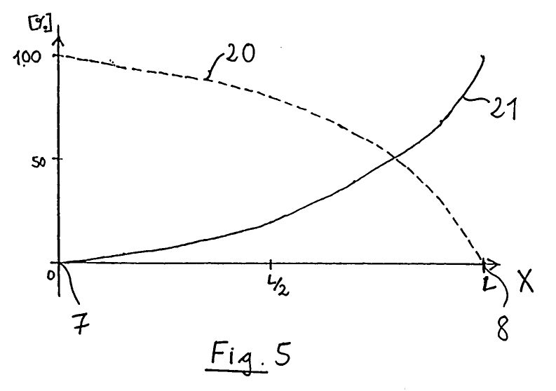

The embodiment of an assembly schematically shown in FIG. 4 differs from the one shown in FIG. 2 in that the adhesion-enhancing second layer is entirely composed of an ion mixing layer 6. The material composition of the ion mixing layer 6 changes continuously from a first zone 7 adjacent to the optical component 1 consisting predominantly of MgF₂ to a second zone 8 adjacent to the adhesive-protecting layer 3, consisting predominantly of Ta₂O₅. The fluoride material MgF₂ of the first zone 7 is, by its fluoride nature, capable of increasing interface adhesion between the ion mixing layer 6 and the adjacent optical component 1 consisting of CaF₂. The oxide material Ta₂O₅ of the second zone 8 is, by its oxide nature, capable of increasing interface adhesion between the ion mixing layer 6 and the adjacent adhesive-protecting layer 3. The continuous change of material composition from the first to the second zone, i.e. from fluoride to oxide material, is formed by ion mixing.

FIG. 5 shows a schematic diagram of the composition of the ion mixing layer 6 of FIG. 4. The x-coordinate represents the x-axis shown in FIG. 4, of which a part ranging from the first zone 7 at the origin up to the second zone 8 marked by an L is shown, so that the entire thickness of the ion mixing layer 6 is covered. The y-coordinate shows the composition of the ion mixing layer 6 in percent of volume. The ion mixing layer 6 is a binary layer consisting of a mix of MgF₂, represented by a dashed line 20 in the diagram, and of Ta₂O₅, represented by a continuous line 21. The ion mixing layer consists to a great extent of MgF₂, as can be readily seen by the fact that the dashed line 20 representing MgF₂ is above the continuous line 21 representing Ta₂O₅ from the first zone 7 until an equal composition of both components (50% each) is attained close to the second zone 8. Such a composition may result from an ion mixing process as described above. The ion mixing layer 6 is by no means limited to a layer consisting of two materials for it may be advantageous to use three or more materials, such as inert gas ions, as constituents.

It is alternatively possible to change the material composition between the first 7 and the second zone 8 stepwise, for example by applying a plurality of layers of a different material composition between the first zone 7 and the second zone 8.

Depending on the particular embodiment, the adhesion-enhancing layer 2 of FIG. 2 has a thickness in a range from about 1 to about 500 nm, preferably from about 1 nm to about 200 nm. The combination of the adhesion-enhancing layer 2 and the ion mixing layer 6 of FIG. 3 should also fall in that range. The thickness of the ion mixing layer may be lower than about 100 nm, preferably lower than 50 nm. The thickness of the ion mixing layer of FIG. 4 should fall in a range from about 1 to about 500 nm, preferably from about 1 to about 200 nm. It may be advantageous not to exceed a certain thickness of the above-mentioned layers, as layer production time and fissure formation both increase with increasing layer thickness.

The use of an adhesion-enhancing layer such as layer 2 may also be favourable if the optical component is not polished outside of its transmitting zone, such that the optical component has a relatively high surface roughness outside of the transmitting zone 10. In this case, the adhesion-enhancing layer may also be used to mediate between the large surface roughness of the optical component and the small surface roughness favourable for applying the adhesion-protecting layer.

In addition to the use in projection systems and/or illumination systems, the assemblies according to the invention are also suitable for repair systems or wafer inspection systems for microlithography, for UV laser optics, for UV microscopes and especially for exit windows of lasers.

The above description of the preferred embodiments has been given by way of example. From the disclosure given, those skilled in the art will not only understand the present invention and its attendant advantages, but will also find apparent various changes and modifications to the structures and methods disclosed, e.g. as indicated above. It is sought, therefore, to cover all such changes and modifications as fall within the spirit and scope of the invention, as defined by the appended claims, and equivalents thereof.

1. An assembly, comprising:
a holder;
an optical component suited to transmit radiation in a first region of ultraviolet (UV) radiation and adhered to the holder with an adhesive, said adhesive being suited to harden by radiation of a second region of ultraviolet radiation;
a first layer disposed between said optical component and said adhesive, said first layer being suited to transmit radiation of the second region of UV radiation and to substantially obstruct transmission of UV radiation of the first region by at least one of absorption and reflection, wherein said optical component has a transmitting zone and said first layer is located outside of the transmitting zone, and
a second layer enhancing adhesion between the optical component and said first layer, said second layer being disposed between said first layer and said optical component.

2. The assembly according to claim 1, wherein a thermal expansion coefficient of said second layer is closer to a thermal expansion coefficient of said optical component than to a thermal expansion coefficient of said first layer.

3. The assembly according to claim 1, wherein said optical component is composed of a first fluoride material and said second layer is substantially composed of a second fluoride material at least in a zone adjacent to said optical component.

4. The assembly according to claim 3, in which said second fluoride material is selected from the group consisting of MgF₂, LaF₃, GdF₃, NdF₃, AlF₃, cryolite, chiolite, CeFₓ, YFₓ, and mixtures thereof.

5. The assembly according to claim 1, wherein said optical component is composed of CaF₂.

6. The assembly according to claim 1, wherein said first layer is at least in part composed of an oxide material.

7. The assembly according to claim 1, wherein said first layer is composed essentially of Ta₂O₅.

8. The assembly according to claim 1, wherein said second layer has a thickness in a range from about 1 nm to about 200 nm.

9. The assembly according to claim 1, wherein said second layer is a gradient layer comprising a first zone adjacent to said optical component consisting of a first material and a second zone adjacent to said first layer consisting of a second material, the second material being different from the first material.

10. The assembly according to claim 9, wherein a transition of material composition between the first zone and the second zone is accomplished by a continuous change in composition.

11. The assembly according to claim 9, wherein a transition of material composition between the first zone and the second zone includes a stepwise change in composition by arranging a plurality of layers of a different material composition between the first zone and the second zone.

12. The assembly according to claim 1, wherein said second layer comprises a border layer adjacent to said first layer, said border layer consisting essentially of an ion mixing layer.

13. The assembly according to claim 1, wherein said second layer essentially forms an ion mixing layer.

14. The assembly according to claim 13 wherein said second layer includes an ion mixing layer having a thickness in a range from about 1 nm to about 100 nm.

15. The assembly according to claim 1, wherein said holder is made from at least one material selected from the group consisting of metal, plastics and ceramics.

16. The assembly according to claim 1, in which the first region of UV radiation includes laser radiation at about 248 nm, about 193 nm or about 157 nm.

17. The assembly according to claim 1, in which the second region of UV radiation consists only of wavelengths larger than 300 nm, including a Hg-I line at 365 nm.

18. The assembly according to claim 1, wherein a combination of said first layer and said second layer attains over 60% transmission in the second region of UV radiation where the adhesive hardens.

19. The assembly according to claim 1, in which a combination of said first layer and said second layer attains less than 5% transmission at wavelengths below 250 nm.

20. A process for producing an optical assembly utilizing an optical component, a first layer, a second layer, and an adhesive, comprising:
coating the optical component, which is suited to transmit radiation in a first region of ultraviolet (UV) radiation, on a surface outside of a transmitting zone with the second layer;
coating the second layer with a first layer, for substantially obstructing transmission of UV radiation of the first region by at least one of absorption and reflection and for substantially transmitting radiation of a second region of UV radiation in which the adhesive hardens, the second layer enhancing adhesion between the optical component and the first layer,
applying the adhesive between said first layer and a holder, and
hardening the adhesive by irradiating the adhesive with UV radiation in the second region of radiation that passes through the optical component and the first and second layer.

21. The process according to claim 20, further comprising forming a border layer on the second layer, the border layer being adjacent to the first layer and being formed by ion mixing.

22. The process according to claim 20, further comprising forming the second layer essentially by ion mixing.

23. The process according to claim 20, wherein at least one of the first layer and the second layer is produced by at least one thin film process selected from the group consisting of vapor deposition, sputtering, physical vapor deposition, spraying, chemical vapor deposition, ion assisted deposition, plasma enhanced chemical vapor deposition, and spincoating.

24. An optical component adhered to a holder by an adhesive, and coated by a first layer and a second layer, wherein said optical component has a transmitting zone and a surface arranged outside of the transmitting zone, said surface being coated by said second layer, said second layer being coated by said first layer protecting said adhesive from radiation in a first region of ultraviolet (UV) radiation transmitted by said optical component during use of said optical component, said second layer being adapted for enhancing adhesion between said optical component and said first layer.

25. A microlithography projection exposure apparatus including an illumination system and a projection system, comprising at least one assembly having:
a holder;
an optical component suited to transmit radiation in a first region of ultraviolet (UV) radiation and adhered to the holder with an adhesive, said adhesive being suited to harden by radiation of a second region of ultraviolet radiation;
a first layer disposed between said optical component and said adhesive, said first layer being suited to transmit radiation of the second region of UV radiation and to substantially obstruct transmission of UV radiation of the first region by at least one of absorption and reflection, wherein said optical component has a transmitting zone and said first layer is located outside of the transmitting zone, and
a second layer enhancing adhesion between the optical component and said first layer, said second layer being disposed between said first layer and said optical component.
